(19) United States
(12) Patent Application Publication
(10) Pub. No.: US 2016/0140471 A1
(43) Pub. Date: May 19, 2016

(54) SHEDDING AMOUNT ASSIGNMENT METHOD AND DEVICE

(71) Applicant: INSTITUTE FOR INFORMATION INDUSTRY, TAIPEI CITY (TW)

(72) Inventors: YU-TING CHEN, KAOHSIUNG CITY (TW); CHIA-SHIN YEN, TAIPEI CITY (TW)

(21) Appl. No.: 14/642,836

(22) Filed: Mar. 10, 2015

(30) Foreign Application Priority Data
Nov. 14, 2014 (TW) 103139601

(51) Int. Cl. G06Q 10/06; G06F 17/18

(52) U.S. Cl. CPC G06Q 10/06315; G06F 17/18

(57) ABSTRACT

A shedding assignment method executed in a shedding assignment device of an aggregator has steps as follows. According to multiple historical data of historical shedding events, one user with a highest participating probability among non-selected users is selected, and a probability model of the selected user is generated. According to the probability model of the selected user, an expected shedding amount of the selected user is calculated. A total expected shedding amount is added with the expected shedding amount of the selected user to update the total expected shedding amount. If the total expected shedding amount is larger than or equal to a demand amount, at least corresponding one shedding event is published to at least one of the users, wherein a shedding amount of the shedding event to the user is obtained according to the probability model of the user.

### BACKGROUND

1. Technical Field

The present disclosure relates to a shedding amount assignment method and device; in particular, to the shedding amount assignment method and device which considers the acceptance levels of users.

2. Description of Related Art

The electronic devices and appliances now are driven by electric power, and thus the power supply end, such as a power company, generates electric power by transducing thermal, nuclear, or tidal power, and provides the electric power to the power receiving end. The power generating cost usually is higher in peak hour than that in non-peak hour, and now the government encourages the citizen and family to save the electric power and reduce the carbon emission. Thus, between the power receiving end and power supply end, there is an aggregator for negotiating the users to participate in the shedding events and assigning the shedding amounts to the users, so as to reduce the demand amount of the electric power.

Furthermore, the aggregator and the power supply end have a specific contract therebetween, and the specific contract specifies that the aggregator can request the profit from the power supply end when the aggregator has achieved requested shedding events (i.e. make the actual total shedding amount of the users not less than the requested total shedding amount of the power supply end). In addition, the aggregator and users have also a specific contract therebetween, and the specific contract specifies that the user can benefit discount of the electric power from the power supply end through the aggregator if the user has participated in the requested shedding event without dropping out the participated shedding event (i.e. make the actual shedding amount of the user not less than the requested shedding amount which the aggregator requests the user respectively).

However, after the aggregator may send the shedding request to the user, the user may participate in the shedding event of the shedding request, but then drop out the shedding event due to some cause. Thus, the requested total shedding amount of the power supply end is larger than the actual total shedding amount of the users, i.e. the actual total shedding amount of the users are not large expectedly. Accordingly, in the demand amount negotiation, the aggregator needs a criterion to reasonably assign the shedding amount of each user, such that a high probability that the user participates in the shedding event entirely is achieved.

U.S. Pub. 20110258018 A1 disclosed a demand amount negotiation method, wherein the aggregator groups the users into different user groups based on the historical shedding events, and then assigns the shedding amount for one or more user groups. U.S. Pub. 20140062195 A1 disclosed other one demand amount negotiation method, wherein the aggregator uses historical shedding events to select one or more users to participate in the shedding event, and then assigns the shedding amount to users according to the shedding abilities of the users. The above two demand amount negotiation methods do not consider the acceptance levels of the users, thus decreasing the probability that each user drops out the shedding event is limited.

### SUMMARY

An exemplary embodiment of the present disclosure provides a shedding amount assignment method, executed in a shedding amount assignment device of an aggregator. Steps of the shedding amount assignment method are illustrated as follows. Multiple historical data of historical shedding events of users are collected. A participating probability of each user for participating in the historical shedding events is calculated according to the multiple historical data, one user with a highest participating probability among the users is selected, and a probability model of the selected user is generated. An expected shedding amount of the selected user is calculated according to the probability model of the selected user. A total expected shedding amount is added with the expected shedding amount of the selected user to update the total expected shedding amount. If the total expected shedding amount is larger than or equal to a demand amount which a power supply end requests the aggregator, at least corresponding one shedding event to the at least one of the users is published, wherein a shedding amount of the shedding event to the user is obtained according to the probability model of the user.

An exemplary embodiment of the present disclosure provides a shedding amount assignment device, used to execute a shedding amount assignment method, comprising a user selection module, a probability modeling module, a probability database, an expected shedding amount calculating module, an accumulation module, a comparison module, and a shedding event publishing module. The user selection module is used to collect multiple historical data of historical shedding events of users, calculate a participating probability of each user for participating in the historical shedding events according to the multiple historical data, and select one user with a highest participating probability among the users. The probability modeling module is used to generate a complete probability model of the selected user according to the multiple historical data of historical shedding events of the selected user. The probability database is used to store the probability model. The expected shedding amount calculating module is used to calculate an expected shedding amount of the selected user according to the probability model of the selected user. The accumulation module is used to add a total expected shedding amount with the expected shedding amount of the selected user to update the total expected shedding amount. The comparison module is used to compare the total expected shedding amount with a demand amount which a power supply end requests the aggregator. The shedding event publishing module, used to publish at least corresponding one shedding event to the at least one of the users when the total expected shedding amount is larger than or equal to a demand amount which a power supply end requests the aggregator, wherein a shedding amount of the shedding event to the user is obtained according to the probability model of the user.

To sum up, the shedding amount assignment method and device provided by the exemplary embodiment of the present disclosure can reduce the extra traffic between the users and the aggregator.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings provide a further understanding to the present disclosure, and are incorporated in and constitute a part of this specification. The drawings illustrate exemplary embodiments of the present disclosure and, together with the description, serve to explain the principles of the present disclosure.

FIG. 1 is a schematic diagram of a power supply system according to an exemplary embodiment of the present disclosure.

FIG. 2 is a block diagram of a shedding amount assignment device according to an exemplary embodiment of the present disclosure.

FIG. 3 is a flow chart of a shedding amount assignment method according to an exemplary embodiment of the present disclosure.

FIG. 4 a schematic diagram showing a probability model of a selected user generated based on multiple historical data of shedding events of the selected user according to an exemplary embodiment of the present disclosure.

FIG. 5 is a schematic diagram showing a probability model of a selected user at a specific shedding time according to an exemplary embodiment of the present disclosure.

FIG. 6 is a schematic diagram showing a probability model of a selected user which is adjusted based on multiple historical data of historical shedding events of the selected user according to an exemplary embodiment of the present disclosure.

FIG. 7 is a schematic diagram showing a complete probability model of a selected user according to an exemplary embodiment of the present disclosure, and the complete probability model of a selected user is generated by interpolating one or more deficiency portions of the probability model of the selected user.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

An exemplary embodiment of the present disclosure provides a shedding amount assignment method and device used by the aggregator for assigning shedding amounts to users. The shedding amount assignment method and device assign the most acceptable shedding amounts to the users based on the participating probabilities which the users participate in the historical shedding events (i.e. considering both of historical shedding events and user preference), and publish the corresponding shedding events to the users, thus reducing probabilities which the user participate in and then drop out the shedding events (i.e. withdrawn probabilities of the user) and the traffic between the aggregator and the users. The following descriptions illustrate detailed implementations of the shedding amount assignment method and device.

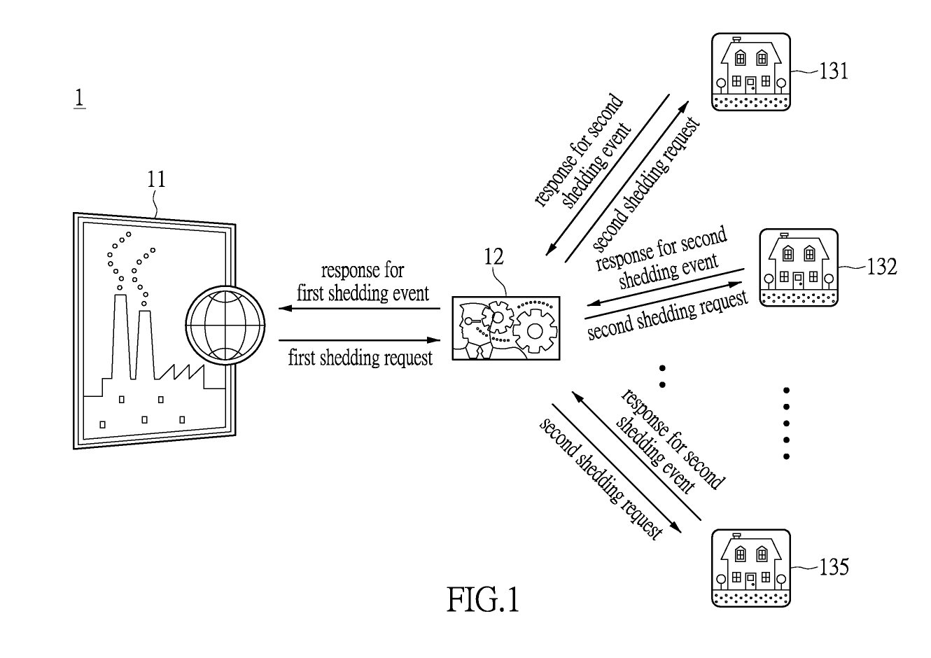

Referring to FIG. 1, FIG. 1 is a schematic diagram of a power supply system according to an exemplary embodiment of the present disclosure. The power supply system 1 comprises a power supply end 11, an aggregator 12, and multiple users 131 through 135. In the exemplary embodiment, five users are taken as an example, but the present disclosure does not limit the number of the users. The aggregator 12 is used to negotiate with the power supply end 11 and the users 131 through 135 to achieve a demand amount, and transmits the negotiation result to the power supply end 11, such that the power supply end 11 can correspondingly provide power to the users 131 through 135.

In peak hour, to retard the power usage, the power supply end 11 transmits a first shedding request to the aggregator 12. After the aggregator 12 receives the first shedding request, the aggregator 12 further sends a second shedding request to the users 131 through 135. The users 131 through 135 can response the aggregator 12 in response to the received second shedding requests to indicate whether the users 131 through 135 accept and execute the shedding events of the second shedding requests from the aggregator 12. The aggregator 12 can further set a response period for the users 131 through 135, and if the user does not response the second shedding request in the response period, the aggregator 12 considers the user gives up participating in the shedding event.

The first shedding request from the power supply end 11 comprises a first shedding event which the power supply end 11 requests the aggregator 12, and the first shedding event contains a demand amount requested by the power supply end 11. The second shedding request from the aggregator 12 to the user comprises a second shedding event (i.e. the shedding event of the user) which the aggregator 12 requests the user. The second shedding events to the users 131 through 135 may be different from each other, and the second shedding events respectively comprise shedding amounts assigned to the users 131 through 135.

The aggregator 12 receives the responses of the users 131 through 135, and then performs a statistical calculation on the shedding amounts. The aggregator 12 responses the first shedding request of the power supply end 11 according to the statistical result of the shedding amounts, so as to indicate the power supply end 11 whether the aggregator 12 can execute the first shedding request. In one exemplary embodiment, if the statistical result of the shedding amounts which is obtained by the aggregator 12 is larger than or equal to the demand amount requested by the power supply end 11, the aggregator 12 replies the power supply end 11 that the aggregator 12 accepts and executes the first shedding request; otherwise, if the statistical result of the shedding amounts is less than the demand amount, the aggregator 12 does not responses the power supply end 11. Next, the aggregator 12 can request the power supply end 11 to adjust the demand amount, and to transmit the new shedding request with the adjusted demand amount.

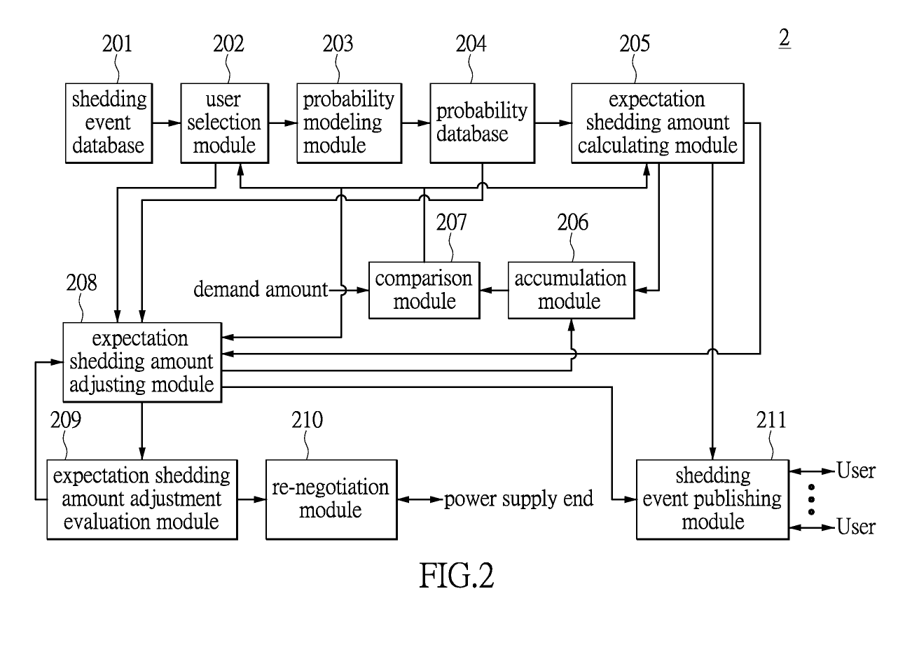

Referring to FIG. 2, FIG. 2 is a block diagram of a shedding amount assignment device according to an exemplary embodiment of the present disclosure. The shedding amount assignment device 2 can be used by the aggregator, so as to calculate the shedding amounts to the users. The shedding amount assignment device 2 comprises one or more circuits to configure to a shedding event database 201, a user selection module 202, a probability modeling module 203, a probability database 204, an expected shedding amount calculating module 205, an accumulation module 206, a comparison module 207, an expected shedding amount adjusting module 208, an expected shedding amount adjustment evaluation module 209, a re-negotiation module 210, and a shedding event publishing module 211.

In FIG. 2, the user selection module 202 is electrically connected to the shedding event database 201, the probability modeling module 203, the expected shedding amount calculating module 205, and the expected shedding amount adjusting module 208. The probability database 204 is electrically connected to the probability modeling module 203, the expected shedding amount calculating module 205, and the expected shedding amount adjusting module 208. The expected shedding amount calculating module 205 is electrically connected to the accumulation module 206, the expected shedding amount adjusting module 208, and the shedding event publishing module 211. The accumulation module 206 is electrically connected to the expected shedding amount adjusting module 208 and the comparison module 207. The comparison module 207 is electrically connected to the user selection module 202, the expected shedding amount adjusting module 208, and the expected shedding amount calculating module 205, and the expected shedding amount adjusting module 208 is electrically connected to the shedding event publishing module 211 and the expected shedding amount adjustment evaluation module 209. The re-negotiation module 210 is electrically connected to the expected shedding amount adjustment evaluation module 209, and linked to the power supply end, and the shedding event publishing module 211 is linked to the users.

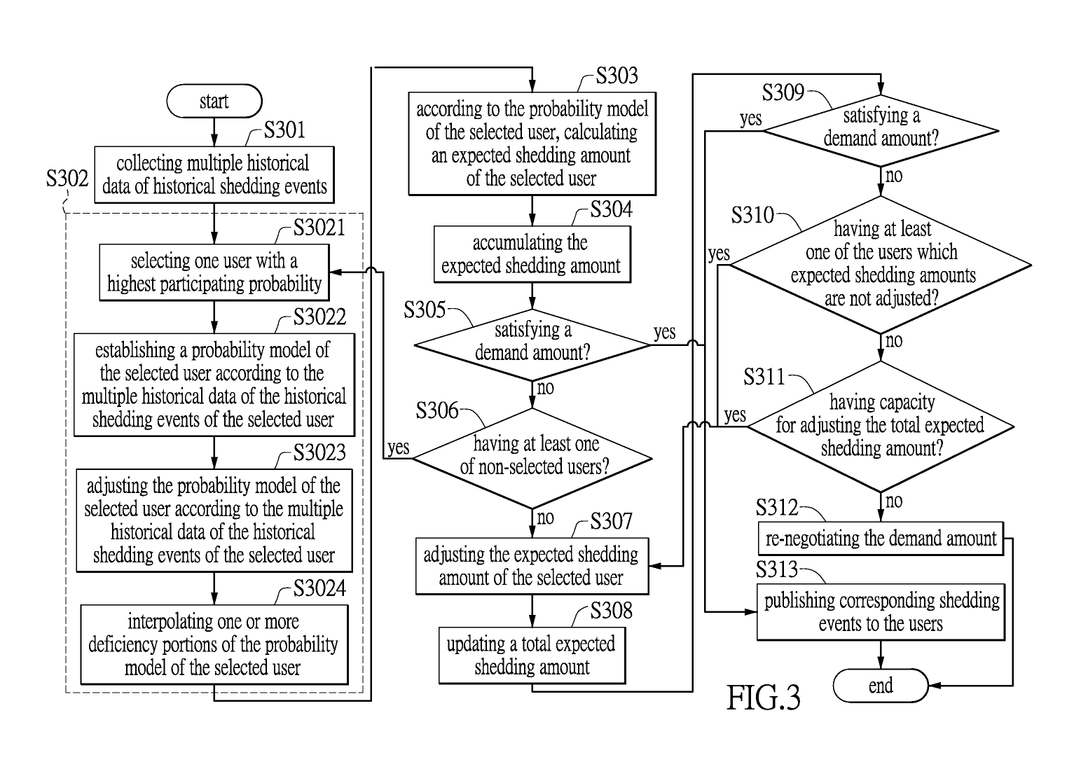

Referring to FIG. 2 and FIG. 3, FIG. 3 is a flow chart of a shedding amount assignment method according to an exemplary embodiment of the present disclosure. The shedding amount assignment method in FIG. 3 can be executed by the shedding amount assignment device 2, but the present disclosure does not limit the implementation of the device for executing the shedding amount assignment method. Firstly, at step S301, when the aggregator receives the shedding request from the power supply end, the user selection module 202 collects the multiple historical data of historical shedding events of users from the shedding event database 201, wherein the multiple historical data of historical shedding events of each user comprise shedding times, durations, shedding amounts, participating information of the historical shedding events, wherein the participating information indicates whether the shedding events are participated in or not.

Next, at step S302, the user selection module 202 selects one user with a highest participating probability among the users according to the multiple historical data of the shedding events, and the probability modeling module 203 generates a complete probability model of the selected user according to the multiple historical data of historical shedding events of the selected user, and then stores the complete probability model in the probability database 204.

The step S302 can comprise steps S3021 through S3024, but the present disclosure does not limit the detailed implementation of the step S302. At step S3021, the user selection module 202 calculates a participating probability of each user for participating in the historical shedding events according to the multiple historical data, and selects one user with a highest participating probability among the users. Moreover, at step S3021, the user selection module 202 counts the total number of historical shedding events of each user and the total participating number which the user participates in the historical shedding events, so as to obtain the participating probability of the user. Then, the user selection module 202 compares the participating probabilities of the users to find a user with the highest participating probability as the selected user.

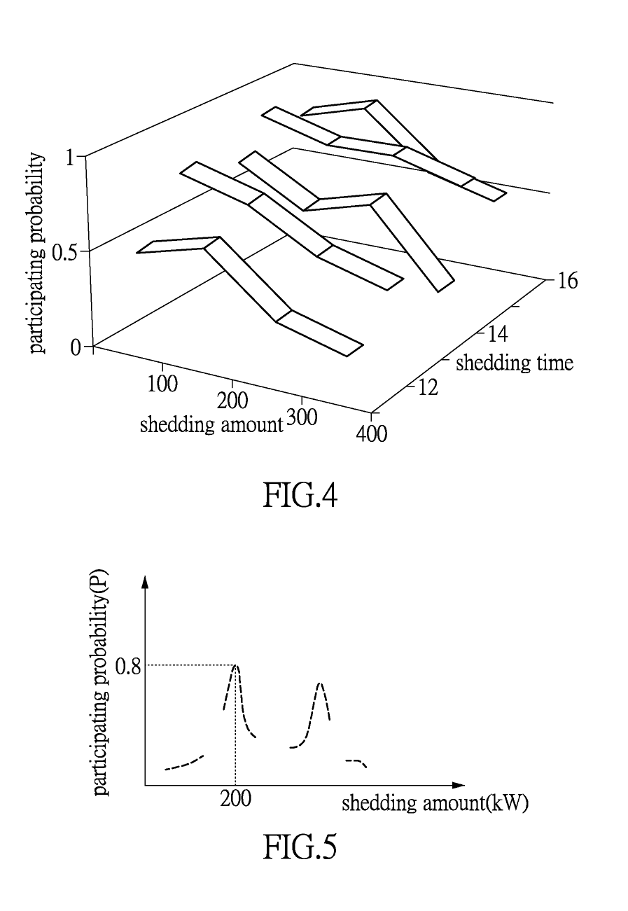

Next, at step S3022, the probability modeling module 203 establishes a probability model of the selected user according to the multiple historical data of historical shedding events of the selected user. Referring to FIG. 4 and FIG. 5, FIG. 4 is a schematic diagram showing a probability model of a selected user generated based on multiple historical data of shedding events of the selected user according to an exemplary embodiment of the present disclosure, and FIG. 5 is a schematic diagram showing a probability model of a selected user in a specific shedding time according to an exemplary embodiment of the present disclosure. In FIG. 4, the probability model of the selected user can be presented by a line graph showing the participating probabilities of different shedding amounts in different shedding time. In the example of FIG. 5, when the shedding time is 14:00 and the shedding amount is 200 kW, the probability which the selected user participates in the shedding event is 0.8.

Next, referring to FIG. 2 and FIG. 3, at step S3023, the probability modeling module 203 adjusts the probability model of the selected user according to the multiple historical data of the historical shedding events of the selected user. For example, the probability model is adjusted according to other parameters in the multiple historical data of the historical shedding events of the selected user, wherein the other parameters are not the variables in the probability model. To put it concretely, when the other parameters are considered, and another participating probability larger than the participating probability (i.e. an average participating probability which considers the other parameters) of the probability model exists, an average value of the maximum participating probability (i.e. the above existed participating probability) and the participating probability in the probability model is calculated, and the average value is set as the participating probability in the probability model, so as to adjust the probability model.

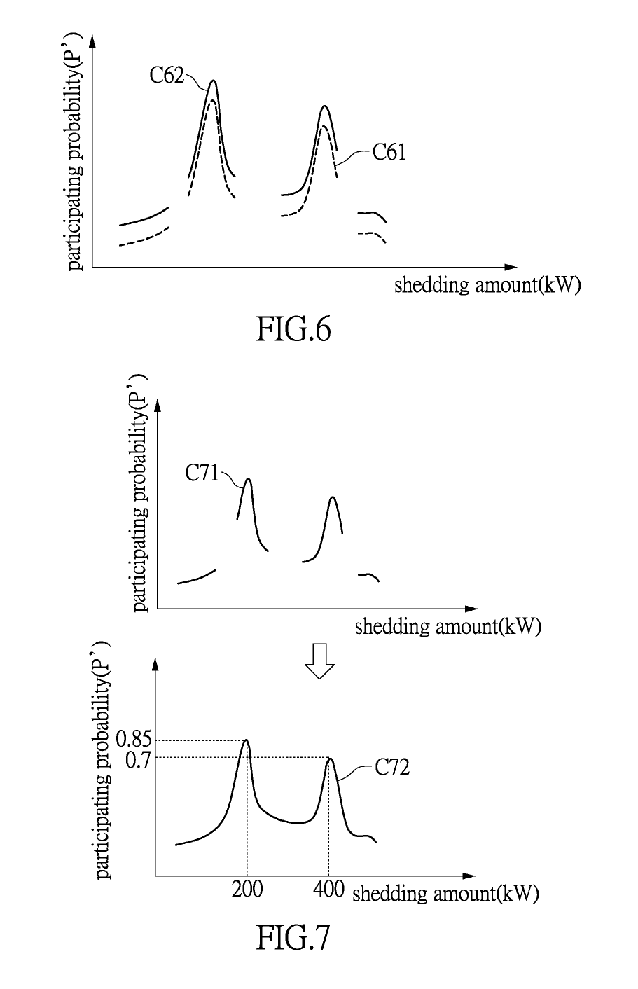

Referring to FIG. 6, FIG. 6 is a schematic diagram showing a probability model of a selected user which is adjusted based on multiple historical data of historical shedding events of the selected user according to an exemplary embodiment of the present disclosure. In FIG. 6, the original probability model at the shedding time of 14:00 is presented by the curve C61, and the adjusted probability model at the shedding time of 14:00 is presented by the curve C62. In the curve C61, when the shedding time is 14:00 and the shedding amount is 200 kW, the probability which the selected user participates in the shedding event is 0.8, and the probability is an average probability considering duration of the historical events of the selected user. For example, when the shedding time is 14:00, the shedding amount is 200 kW, and the probabilities which the selected user may participate in the shedding events with durations of 10 minutes, 30 minutes, and 40 minutes are respectively 0.8, 09, and 07, in the adjusted probability model, the probability which the selected user participates in the shedding event with shedding amount of 200 kW and at the shedding time of 14:00 is adjusted to be 0.85 (i.e. (0.9+0.8)/2).

Referring to FIG. 2 and FIG. 3, at step S3024, the probability modeling module 203 interpolates one or more deficiency portions of the probability model of the selected user to generate the complete probability model of the selected user stored in the probability database 204, wherein the interpolation manner can be interpolation, extrapolation, linear regression, or grey system theory, and the present disclosure is not limited thereto.

Referring to FIG. 7, FIG. 7 is a schematic diagram showing a complete probability model of a selected user generated by interpolating one or more deficiency portions of the probability model of the selected user according to an exemplary embodiment of the present disclosure. The multiple historical data of the shedding events of the selected user may not sufficient to establish a complete probability model, wherein the relation between the shedding amounts and probabilities in the non-complete probability model can be shown as the curve C71. After one or more deficiency portions of the non-complete probability model are interpolated, the relation between the shedding amounts and probabilities in the complete probability model can be shown as the curve C72.

Still referring to FIG. 2 and FIG. 3, at step S303, the expected shedding amount calculating module 205 obtains the probability model of the selected user from the probability database 204, so as to calculate the expected shedding amount of the selected user. At the time of the current shedding event, the highest participating probability in the probability model of the selected user is multiplied by the shedding amount to obtain the expected shedding amount of the selected user. Take FIG. 7 as an example, the expected shedding amount of the selected user is 170 kW (0.85*200 kW). However, the present disclosure does not limit the calculation manner of the expected shedding amount, and in one other exemplary embodiment, the specific portions approaching to the highest participating probability are integrated to obtain the expected shedding amount of the selected user.

Next, at step S304, the accumulation module 206 accumulates the expected shedding amount, or adds the currently calculated expected shedding amount to the last updated total expected shedding amount, so as to update the total expected shedding amount. At step S305, the comparison module 207 compares the demand amount requested by the power supply end and the total expected shedding amount, so as to determine whether the total expected shedding amount can satisfy with the demand amount (i.e. whether the total expected shedding amount is larger than or equal to the demand amount). If the total expected shedding amount can satisfy with the demand amount, step S313 is then executed; otherwise, step S306 is then executed.

When the output result of the comparison module 207 indicates that the total expected shedding amount cannot satisfy with the demand amount, at step S306, the user selection module 202 determines whether at least one of the users has not been selected. If at least a user has not been selected, step S3021 is executed again; otherwise, step S307 is executed. In short, if the user selection module 202 has selected all of the users, but unfortunately, the total expected shedding amount of the users still cannot satisfy with the demand amount, step S307 is then executed; if the total expected shedding amount of the users can satisfy with the demand amount after the user selection module 202 has selected partial or all users, step S313 is executed to assign shedding amounts (for example, expected shedding amounts of the users) to the users, wherein the shedding amounts are obtained according to the probability model.

At step S307, the expected shedding amount adjusting module 208 is controlled by the user selection module 202 to obtain the probability model of one user from the probability database 204, so as to adjust the expected shedding amount of the user, wherein the adjusted expected shedding amount is larger than the non-adjusted expected shedding amount. At the time of the current shedding event, a second highest participating probability in the probability model of the user is multiplied by a shedding amount corresponding to the second highest participating probability, so as to obtain the adjusted expected shedding amount of the user. Take FIG. 7 as an example, the adjusted expected shedding amount of the user is 280 kW (0.7*400 kW). However, the present disclosure does not limit the calculation manner for adjusting the expected shedding amount, and in one other exemplary embodiment, the specific portions approaching to the second highest participating probability are integrated to obtain the adjusted expected shedding amount of the user.

At step S308, the expected shedding amount adjusting module 208 indicates the accumulation module 206 to update the total expected shedding amount according to the adjusted expected shedding amount of the user. At step S309, the comparison module 207 compares the demand amount requested by the power supply end and the total expected shedding amount, so as to determine whether the total expected shedding amount can satisfy with the demand amount. If the total expected shedding amount satisfies with the demand amount, step S313 is executed; otherwise, step S310 is executed.

At step S310, the expected shedding amount adjusting module 208 determines whether at least one expected shedding amount of the users has not been adjusted. In short, if the user selection module 202 has adjusted all expected shedding amounts of the users once, but unfortunately, the total expected shedding amount of the users cannot satisfy with the demand amount, step S311 is then executed. If the total expected shedding amount of the users can satisfy with the demand amount after the expected shedding amount adjusting module 208 has adjusted partial or all expected shedding amounts of the users, step S313 is then executed to assign shedding amounts (for example, adjusted expected shedding amounts of the users) to the users, wherein the shedding amounts are obtained according to the probability model.

At step S311, the expected shedding amount adjustment evaluation module 209 evaluates whether all expected shedding amounts of the users can be adjusted again. For example, if the product of other one higher probability and the corresponding shedding amount cannot make the current total expected shedding amount increase, it is determined that there is no capacity for further adjusting the total expected shedding amount. If all expected shedding amounts of the users can be adjusted again, step S307 is executed; otherwise, step S312 is executed. At step S312, the re-negotiation module 210 re-negotiates the demand amount with the power supply end. At step S313, the shedding event publishing module 211 publishes the shedding events to the users to assign shedding amounts, wherein the shedding amounts are obtained according to the probability models of the users, such as the calculated or adjusted expected shedding amounts of the users.

To sum up, the shedding amount assignment method and device considers both of historical shedding events and user preference, and publishes the corresponding shedding events to the users, thus reducing probabilities which the user participate in and then drop out the shedding and the traffic between the aggregator and the users.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A shedding amount assignment method, executed in a shedding amount assignment device of a aggregator, comprising:
(A) collecting multiple historical data of historical shedding events of users;
(B) according to the multiple historical data, calculating a participating probability of each user for participating in the historical shedding events, selecting one user with a highest participating probability among the users, and generating a probability model of the selected user;
(C) according to the probability model of the selected user, calculating an expected shedding amount of the selected user;
(D) adding a total expected shedding amount with the expected shedding amount of the selected user to update the total expected shedding amount;
(E) if the total expected shedding amount is larger than or equal to a demand amount which a power supply end requests the aggregator, publishing at least corresponding one shedding event to the at least one of the users, wherein a shedding amount of the shedding event to the user is obtained according to the probability model of the user.

2. The shedding amount assignment method according to claim 1, further comprising:
(F) if the total expected shedding amount is less than the demand amount, determining whether at least one of the users has not been selected; and
(G) if at least one of the users has not been selected, executing the steps (B) through (E).

3. The shedding amount assignment method according to claim 2, further comprising:
(H) if all of the users have been selected, adjusting the expected shedding amount of one user, and updating the total expected shedding amount accordingly, wherein the adjusted expected shedding amount is larger than the non-adjusted expected shedding amount;
(I) determining whether the total expected shedding amount updated at the step (H) is larger than or equal to the demand amount; and
(J) if the total expected shedding amount updated at the step (H) is larger than or equal to the demand amount, executing step (E).

4. The shedding amount assignment method according to claim 3, further comprising:
(K) if the total expected shedding amount updated at the step (H) is less than the demand amount, determining whether at least one expected shedding amount of the users has not been adjusted;
(L) if at least one expected shedding amount of the users has not been adjusted, executing the steps (H) and (I).

5. The shedding amount assignment method according to claim 4, further comprising:
(M) if all of the expected shedding amounts of the users have been adjusted, determining whether at least one expected shedding amount of the users can be further adjusted;
(N) if at least one expected shedding amount of the users can be further adjusted, executing the steps (H) and (I).

6. The shedding amount assignment method according to claim 5, further comprising:
(O) if all expected shedding amounts of the users cannot be further adjusted, re-negotiating with demand amount with the power supply end.

7. The shedding amount assignment method according to claim 1, wherein the step (B) comprises:
(B1) according to the multiple historical data, selecting the user with a highest participating probability among the users;
(B2) establishing the probability model of the selected user according to the multiple historical data of the selected user;
(B3) adjusting the probability model of the selected user according to the multiple historical data of the selected user; and
(B4) interpolating one or more deficiency portions of the probability model of the selected user to update the probability model of the selected user.

8. The shedding amount assignment method according to claim 1, wherein at the step (C), the highest participating probability in the probability model of the selected user is multiplied by a shedding amount corresponding to the highest participating probability, so as to generate the expected shedding amount of the selected user.

9. The shedding amount assignment method according to claim 3, wherein a second highest participating probability in the probability model of the user which expected shedding amount can be adjusted is multiplied by a shedding amount corresponding to the second highest participating probability, so as to adjust the expected shedding amount of the user.

10. A shedding amount assignment device, used to execute a shedding amount assignment method, comprising:
a user selection module, used to collect multiple historical data of historical shedding events of users, calculate a participating probability of each user for participating in the historical shedding events according to the multiple historical data, and select one user with a highest participating probability among the users;
a probability modeling module, used to generate a complete probability model of the selected user according to the multiple historical data of historical shedding events of the selected user;
a probability database, used to store the probability model;
an expected shedding amount calculating module, used to calculate an expected shedding amount of the selected user according to the probability model of the selected user;
an accumulation module, used to add a total expected shedding amount with the expected shedding amount of the selected user to update the total expected shedding amount;
a comparison module, used to compare the total expected shedding amount with a demand amount which a power supply end requests the aggregator; and
a shedding event publishing module, used to publish at least corresponding one shedding event to the at least one of the users when the total expected shedding amount is larger than or equal to a demand amount which a power supply end requests the aggregator;
wherein a shedding amount of the shedding event to the user is obtained according to the probability model of the user.
